(19) United States
(12) Patent Application Publication
(10) Pub. No.: US 2023/0019157 A1
(43) Pub. Date: Jan. 19, 2023

(54) AUTOMATICALLY ADJUSTING A VEHICLE SEATING AREA BASED ON THE CHARACTERISTICS OF A PASSENGER

(71) Applicant: Motional AD LLC, Boston, MA (US)

(72) Inventor: Ashwin Arunmozhi, Monroeville, PA (US)

(21) Appl. No.: 17/379,074

(22) Filed: Jul. 19, 2021

(51) Int. Cl. B60N 2/02; G06K 9/00; G06K 9/62; G06T 7/70; B60N 2/00; G01S 17/89

(52) U.S. Cl. CPC B60N 2/0244; G06K 9/00369; G06K 9/6256; G06T 7/70; G06K 9/00302; G06K 9/00791; G06K 9/00832; B60N 2/002; G01S 17/89; G06K 9/00348; G06T 2207/30196; G06T 2207/30268; B60N 2002/0268

(57) ABSTRACT

Provided are methods for automatically adjusting a vehicle seating area based on the characteristics of a passenger. In an example method, a seat adjustment system of a vehicle receives sensor data representing at least one measurement of a user exterior to the vehicle, determines at least one characteristic of the based on the sensor data, determines at least one modification to a seating area of the vehicle based on the at least one characteristic of the user, and causes the seating area to be adjusted in accordance with the at least one modification. Systems and computer program products are also provided.

### BACKGROUND

A vehicle (e.g., an autonomous vehicle) can include a seating area within the vehicle that accommodates one or more passengers. As an example, a seating area can include one or more seats that enable passengers to sit in the vehicle (e.g., while operating the vehicle and/or traveling in vehicle to a destination). As another example, a seating area can include one or more restraints (e.g., seat belts) that secure the passengers within the seating area, such as to prevent injury due to sudden movements by the vehicle and/or collisions between the vehicle and another object.

### BRIEF DESCRIPTION OF THE FIGURES

FIG. 1 is an example environment in which a vehicle including one or more components of an autonomous system can be implemented;

FIG. 2 is a diagram of one or more systems of a vehicle including an autonomous system;

FIG. 3 is a diagram of components of one or more devices and/or one or more systems of FIGS. 1 and 2;

FIG. 4A is an block diagram of an example adjustment system for automatically adjusting a vehicle seating area based on the characteristics of a passenger of the vehicle;

FIG. 4B is a block diagram of an example seat adjustment system;

FIG. 4C is a block diagram of an example seat belt adjustment system;

FIG. 5A is a diagram of an implementation of a neural network;

FIGS. 5B and 5C are a diagram illustrating example operation of a CNN;

FIG. 6 is a flowchart of a process for automatically adjusting a vehicle seating based on the characteristics of a passenger.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

### General Overview

In some aspects and/or embodiments, systems, methods, and computer program products described herein include and/or implement a system for automatically adjusting a vehicle seating area based on the characteristics of a passenger. In an example embodiment, prior to a passenger entering a vehicle (e.g., an autonomous vehicle), the vehicle determines the characteristics of the passenger and preemptively adjusts the configuration of its seating area to improve the safety and/or comfort of the passenger.

As an example, as the passenger approaches the vehicle, the vehicle can use external-facing sensors (e.g., LiDAR sensors, cameras, etc.) to determine the physical characteristics of the user, such as the user's height, body type, skeletal structure, body type, gait, etc. Further, the vehicle can retrieve additional information regarding the user, such as the user's age, gender, and personal preferences. Based on this information, the vehicle can automatically determine a set of adjustments to the seating area to accommodate the passenger, and apply those adjustments prior to the user entering the vehicle.

In some embodiments, set of adjustments can be determined, at least in part, based on a neural network. For example, a neural network can be trained based on training data obtained from a population of users. The training data can include characteristics of each of those users (e.g., similar to the information described above), and preferred seating area configurations for those users. Once trained, the neural network can be used to select a set of adjustments to a seating area for a particular passenger, given the characteristics of that passenger.

In some embodiments, the vehicle can make further adjustments to the seating area once the passenger is seated in the vehicle. For example, the vehicle can use interior-facing sensors (e.g., cameras) to determine the position of the passenger's body relative to various components of the seating area (e.g., the armrest, headrest, etc.), and adjust the configuration of the seating area to further improve the passenger's safety and comfort.

By virtue of the implementation of systems, methods, and computer program products described herein, a vehicle can be operated more efficiently and/or in a safer manner. For instance, some of the advantages of these techniques include improving the safety and/or comfort of a passenger while traveling in a vehicle. For example, a seating area can be adjusted to reduce a likelihood of injury to the passenger (e.g., in the event of a collision or sudden movements by the vehicle). As another example, a seating area can be adjusted to enhance the ergonomic properties of the vehicle, such that the user is less fatigued while seated in the vehicle.

Further advantages include reducing the amount of time that a user may spend in adjusting a vehicle's seating area to her preferences. For example, the vehicle can preemptively determine and apply a set of adjustments for a passenger, prior to the passenger entering the vehicle. Accordingly, the passenger is less likely to make adjustments to the configuration of the seating area upon entry, which may otherwise delay travel.

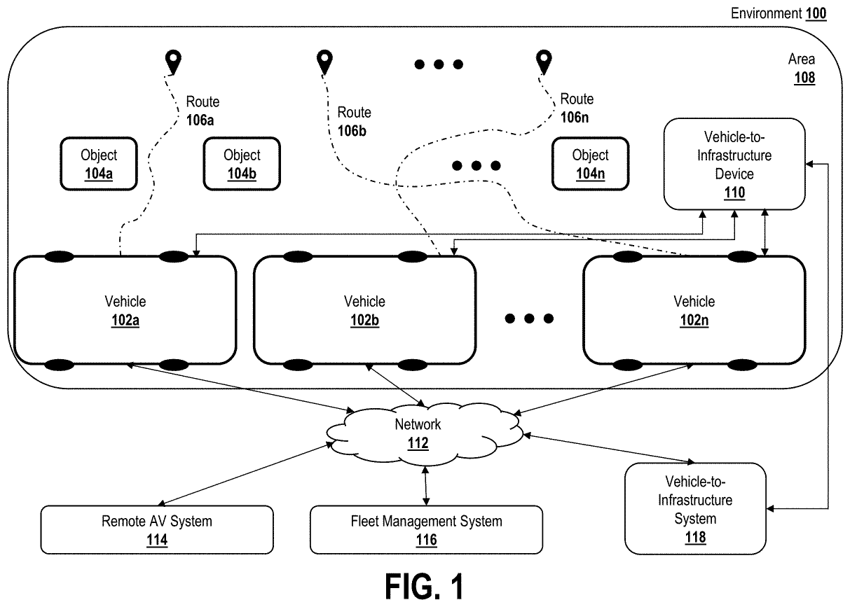

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

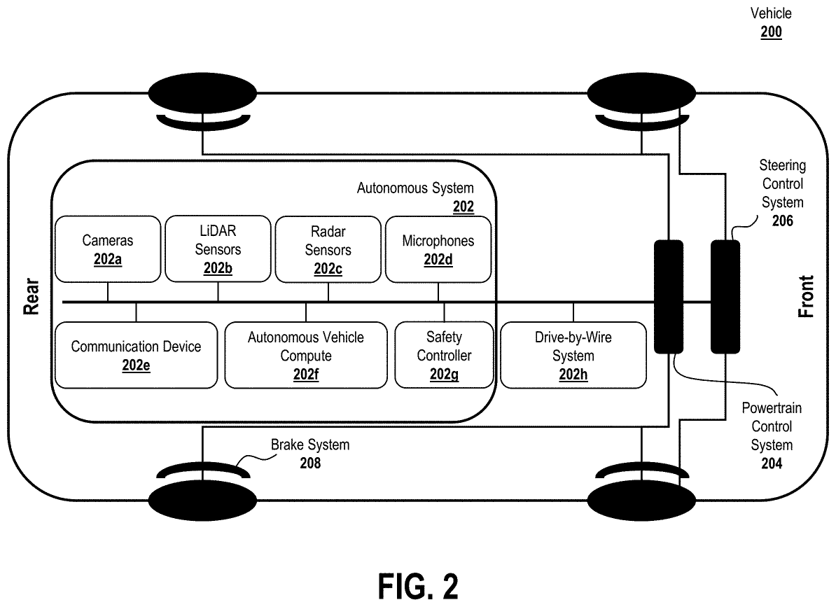

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, remote AV system 114, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 includes autonomous system 202, powertrain control system 204, steering control system 206, and brake system 208. In some embodiments, vehicle 200 is the same as or similar to vehicle 102 (see FIG. 1). In some embodiments, vehicle 102 have autonomous capability (e.g., implement at least one function, feature, device, and/or the like that enable vehicle 200 to be partially or fully operated without human intervention including, without limitation, fully autonomous vehicles (e.g., vehicles that forego reliance on human intervention), highly autonomous vehicles (e.g., vehicles that forego reliance on human intervention in certain situations), and/or the like). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, and drive-by-wire (DBW) system 202h.

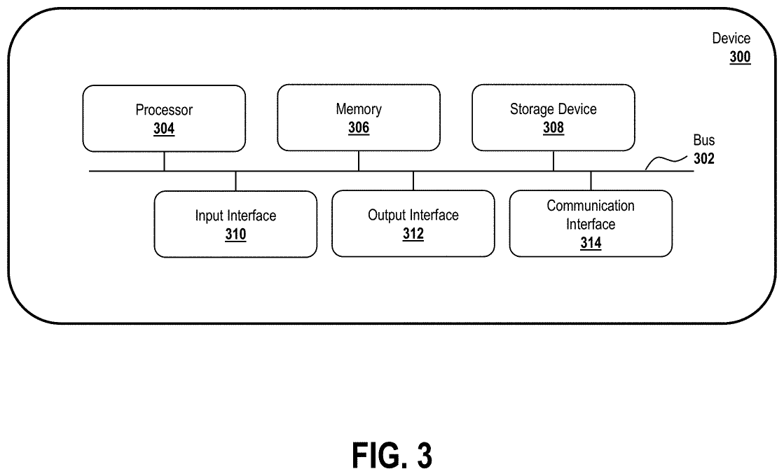

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a charge-coupled device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Laser Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e include at least one device configured to be in communication with cameras 202a, LiDAR sensors 202b, radar sensors 202c, microphones 202d, autonomous vehicle compute 202f, safety controller 202g, and/or DBW system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like) a server (e.g., a computing device including one or more central processing units, graphical processing units, and/or the like), and/or the like. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to start moving forward, stop moving forward, start moving backward, stop moving backward, accelerate in a direction, decelerate in a direction, perform a left turn, perform a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102), at least one device of remote AV system 114, fleet management system 116, V2I system 118, and/or one or more devices of network 112 (e.g., one or more devices of a system of network 112). In some embodiments, one or more devices of vehicles 102 (e.g., one or more devices of a system of vehicles 102), remote AV system 114, fleet management system 116, V2I system 118, and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some embodiments, processor 304 is implemented in hardware, software, or a combination of hardware and software. In some examples, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a WiFi® interface, a cellular network interface, and/or the like.

In some embodiments, device 300 performs one or more processes described herein. Device 300 performs these processes based on processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

Example Adjustment Systems

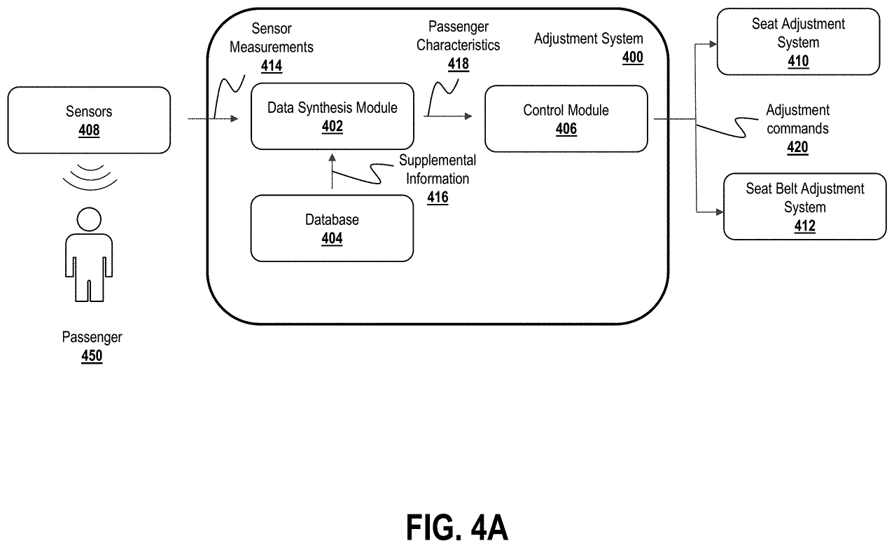

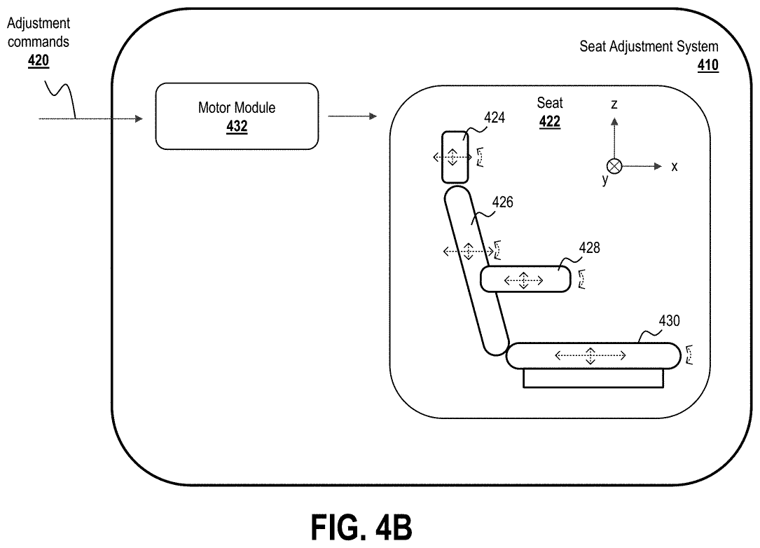

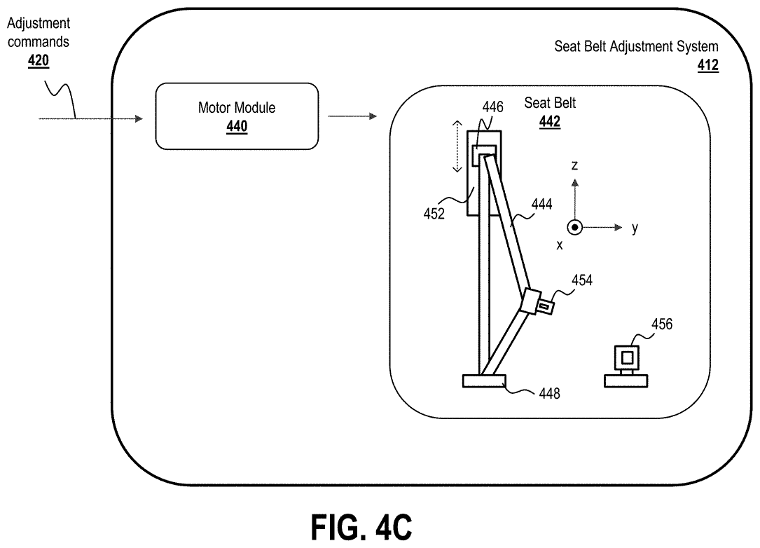

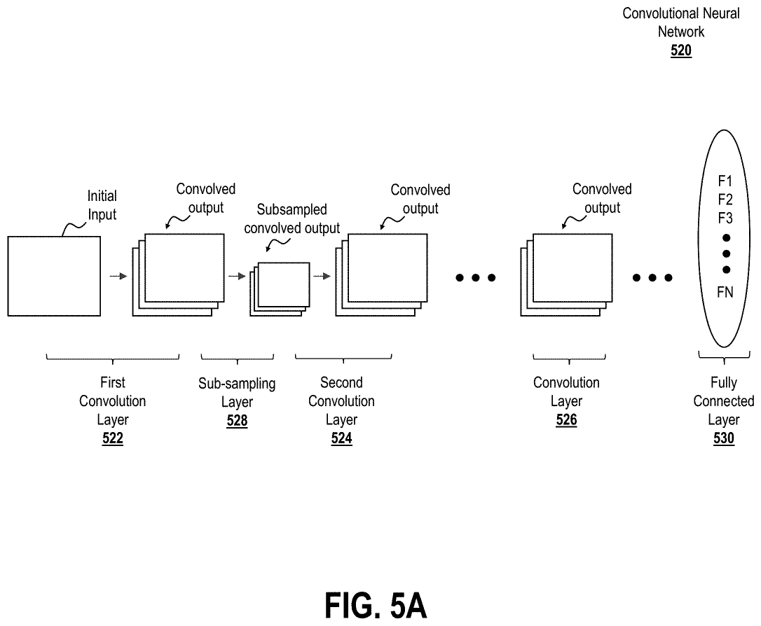

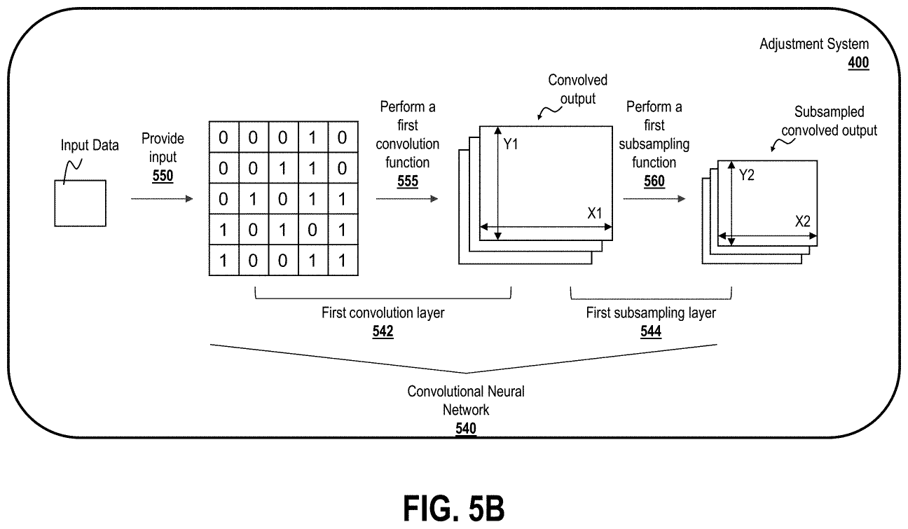

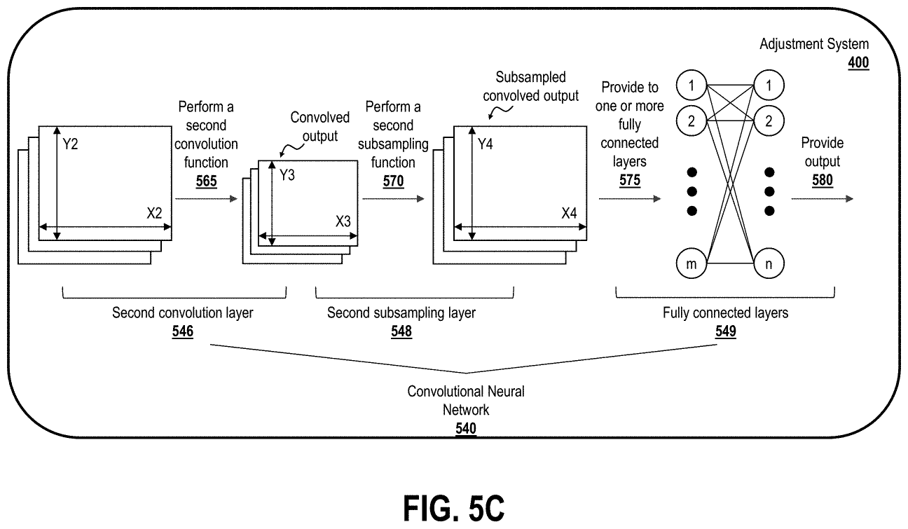

Referring now to FIG. 4A, illustrated is a block diagram of an example adjustment system 400 for automatically adjusting a vehicle seating area based on the characteristics of a passenger of the vehicle (e.g., an autonomous vehicle, such as the vehicle 200). In some embodiments, the adjustment system 400 can be included in or otherwise implemented as a part of the autonomous system 202 the vehicle 200 (e.g., as shown in FIG. 5). In some embodiments, the adjustment system 400 can be implemented as a component of the vehicle 200 that is separate from the autonomous system 202 (e.g., implemented as an additional system in the autonomous system 202). In some embodiments, the adjustment system 400 can be implemented as a component that is separate from the vehicle 200 (e.g., implemented as one or more remote computers, such as a cloud computing environment).

In general, the adjustment system 400 is configured to receive information regarding one or more passengers of the vehicle 200 (e.g., a passenger 450), determine one or more characteristics of the passenger (e.g., while the passenger is approaching the vehicle 200 and/or while the passenger is seated in the vehicle 200), and generate signals that control the configuration of a seating area of the vehicle 200 based on the determined characteristics. In some embodiments, the adjustment system 400 can adjust the position and/or orientation of one or more components of a seat of the vehicle 200 (e.g., a headrest, an arm rest, a back rest, a seat cushion, etc.). In some embodiments, the adjustment system 400 can adjust the position and/or orientation of one or more components of a seat belt of the vehicle 200.

As an example, the adjustment system 400 can receive sensor measurements 414 obtained by one or more sensors 408 representing the passenger 450, the environment in which the passenger r450 is located, and/or the vehicle 200. In some embodiments, the sensors 408 can include one or more of the sensors 202a-202d described with reference to FIG. 2. For example, the sensors 408 can include one or more cameras, LiDAR sensors, radar sensors, and microphones.

In some embodiments, at least some of the sensors 408 can be configured to obtain sensor measurements regarding an exterior of the vehicle 200, including sensor measurements regarding a passenger 450 positioned along the exterior of the vehicle 200 (e.g., a passenger who is approaching the vehicle 200, standing or sitting by the vehicle 200, preparing the board the vehicle 200, etc.). As an example, the sensors 408 can include at least one camera directed to an exterior of the vehicle 200, and configured to capture images and/or videos representing a passenger 450 positioned along the exterior vehicle 200 and the surrounding environment. As another example, the sensors 408 can include at least one LiDAR sensor directed to the exterior or the vehicle 200, and configured to capture images and/or point clouds representing a passenger 450 positioned along an exterior of the vehicle 200 and the surrounding environment. As another example, the sensors 408 can include at least one radar sensor directed to the exterior of the vehicle 200, and configured to capture radar images representing a passenger 450 positioned along the exterior of the vehicle 200 and the surrounding environment. As another example, the sensors 408 can include at least one microphone configured to capture audio signals representing sounds that are generated along an exterior of the vehicle 200 (e.g., such as sounds produced by a passenger 450 positioned along the exterior of the vehicle 200, sounds produced by the surrounding environment, etc.).

In some embodiments, at least some of the sensors 408 can be configured to obtain sensor measurements regarding the interior of the vehicle 200, including sensor measurements regarding a passenger 450 positioned within the interior of the vehicle 200 (e.g., seated within a seating area of the vehicle 200). As an example, the sensors 408 can include at least one camera directed to an interior of the vehicle 200, and configured to capture images and/or videos representing a passenger 450 within the interior of the vehicle 200. As another example, the sensors 408 can include at least one LiDAR sensor directed to the interior or the vehicle 200, and configured to capture images and/or point clouds representing a passenger 450 within the interior of the vehicle 200. As another example, the sensors 408 can include at least one radar sensor directed to the interior of the vehicle 200, and configured to capture radar images representing a passenger 450 within the interior of the vehicle 200. As another example, the sensors 408 can include at least one microphone configured to capture audio signals representing sounds that are audible within the interior of the vehicle 200 (e.g., such as sounds produced by a passenger 450 within the interior of the vehicle 200).

In some embodiments, the sensors 408 can also include one or more sensors configured to measure the pressure and/or force that is applied to one or more components of a seat of the vehicle 200 (e.g., by a passenger 450 that is seated in the seat). For example, the sensors 408 can include sensors configured to measure the sensor pressure and/or force that is applied to a headrest, an arm rest, a back rest, and/or a seat cushion of the seat. In some implementations, the sensor 510 can be configured to determine a weight of the passenger 450 based on the measurements.

Further, the adjustment system 400 can include a database 404 that includes supplemental information 416 regarding the passenger 450 and/or the vehicle 200.

As an example, the database 404 can store supplemental information regarding the identity of one or more users, such as previous passengers of the vehicle 200 and/or a fleet of vehicles of which the vehicle 200 is a part. For instance, the database 404 can include the name of each of the users, contact information for each of the users (e.g., phone number, email address, mailing address, etc.), a unique identifier associated with each of the users (e.g., a serial number or alphanumeric sequence), a username or other login credentials for each of the users, etc.

As another example, the database 404 can include supplemental information including sensor measurements regarding each of the users (e.g., sensor measurement previously obtained by the vehicle 200, another vehicle, and/or a stand-alone sensor system). As described above, example sensor measurements include images, videos, point clouds, radar images, audio signals, pressure measurements, force measurements, etc.

As another example, the database 404 can also store supplemental information regarding the characteristics of each of the users. For instance, the database 404 can include the dimensions of each of the users (e.g., height, width, etc.), the weight of each of the users, the age of each of the users, the gender of each of the users, and/or any other information regarding each of the users.

As another example, the database 404 can also store supplemental information regarding the preferences of each of the users. For instance, the database 404 can include data indicating a preferred seating area configuration of each of the users (e.g., a preferred configuration for the components of a seat and/or a seat belt of a vehicle, such as the position and/or orientation of each of those components). In some embodiments, a user's preferences can be determined based on a user's previous interactions with a vehicle. For example, if a user was previously a passenger of the vehicle 200 (or another vehicle in a fleet), the user may have adjusted one or more components of the seat and/or the seat belt of that vehicle. For instance, the user may have adjusted the position and/or the orientation of the headrest, the arm rest(s), the back rests, the seat cushion(s), and/or the seat belt. Data regarding these adjustments can be stored in the database 404, such that they can be retrieved by the adjustment system 400 (or a different adjustment system that is the same as or similar to adjustment system 400) for subsequent trips by the user.

In some implementations, at least some of the information stored in the database 404 can be retrieved from one or more remote computers, such as a cloud computing environment. As an example, information gathered from one or more vehicles can be transmitted to a cloud computing environment for storage. In turn, the cloud computing environment can distribute the gathered information to one or more other vehicles in a fleet (e.g., such that the information is available to the other vehicles for use). In some implementations, at least some of the information stored in the database 404 can be retrieved from the remote AV system 114, the fleet management system 116, and/or the V2I system 118 (e.g., as described with reference to FIG. 1).

The adjustment system 400 provides at least some of the data received from the sensors 408 and/or the data stored in the database 404 to a data synthesis module 402. The data synthesis module 402 processes the received data, and determines one or more characteristics 418 of the passenger 450.

As an example, the data synthesis module 402 can determine characteristics regarding a gait of the passenger 450. For instance, based on images, videos, point clouds, radar images, and/or any other data received from the sensors 408 and/or the database 404, the data synthesis module 402 can determine the passenger's step length, stride length, step cadence, walking speed, foot angle, hip angle, and/or any other metric regarding the gait of the passenger 450.

As another example, the data synthesis module 402 can determine characteristics regarding a skeletal structure or body type of the passenger 450. For instance, based on images, videos, point clouds, radar images, and/or any other data received from the sensors 408 and/or the database 404, the data synthesis module 402 can determine the passenger's height, torso length, arm length, leg length, or any other dimension of the passenger's body. Further, based on images, videos, point clouds, radar images, and/or any other data received from the sensors 408 and/or the database 404, the data synthesis module 402 can determine a posture of the passenger 450 (e.g., the position and/or orientation of one or more of the user's body parts relative to one another).

As another example, the data synthesis module 402 can determine a passenger's age and/or gender (e.g., based on images, videos, point clouds, radar images, audio signals, and/or any other data received from the sensors 408 and/or the database 404).

As another example, the data synthesis module 402 can determine a passenger's attire. For instance, the data synthesis module 402 can determine the whether a passenger is wearing a shirt, pants, a hat, a dress, a skirt, shorts, socks, eyewear (e.g., corrective glasses, sunglasses, etc.), and/or any other garment.

As another example, the data synthesis module 402 can determine a passenger's facial expressions. Example facial expression include smiling, frowning, staring, etc.

As another example, the data synthesis module 502 can determine a passenger's gaze (e.g., whether the user is looking out of a window of the vehicle 200, looking at another passenger in the vehicle 200, looking at the user device 508, etc.).

As another example, the data synthesis module 402 can determine the identity of the passenger 450. For instance, based on data received from the sensors 408 and/or the database 404, the data synthesis module 402 can determine characteristics regarding the passenger 450, such as the passenger's appearance (e.g., the visual characteristics of the passenger's face, eyes, body, etc.), gait, skeletal structure, body type, attire, facial expressions, etc. Further, the data synthesis module 402 can compare the passenger's characteristics against the characteristics of one or more previously observed users (e.g., previous passengers of the vehicle 200 and/or a fleet of vehicles). If the passenger's characteristics are sufficiently similar to the characteristics of a previously observed user (e.g., a similarity that is greater than a threshold level), the data synthesis module 402 can determine that the passenger 450 is the same person as the previously observed user.

In some embodiments the data synthesis module 402 can make at least some of the determinations described herein based on one or more machine learning models. For example, a machine learning model can be trained to receive input data (e.g., data received from the sensors 408 and/or the database 404), and based on the output data, generate one or more predictions regarding the characteristics of the passenger 450. Example machine learning models are described in further detail with reference to FIGS. 5A-5C.

The data synthesis module 402 provides at least some of the determined information to a control module 406. Based in the received information, the control module 406 generates one or more adjustment commands 420 for adjusting the configuration of a seating area of the vehicle 200 to improve the safety and/or comfort of the passenger 450. As an example, the control module 406 can generate one or more adjustment commands for adjusting a seat of the vehicle 200, and provide the commands to a seat adjustment system 410 for execution. As another example, the control module 406 can generate one or more adjustment commands for adjusting a seat belt of the vehicle 200, and provide the commands to a seat belt adjustment system 412 for execution.

For instance, as shown in FIG. 4B, at least some of the adjustment commands 420 can be transmitted to a motor module 432 of the seat adjustment system 410. The motor module 432 includes one or more actuators (e.g., hydraulic actuators, pneumatic actuators, electrical actuators, mechanical actuators, linear motors, etc.) that are configured to selectively move one or more of the components of a seat 422. For example, the motor module 432 can selectively change the position and/or reorient a head rest 424, a back rest 426, arm rest(s) 428, a seat cushion 430, and/or any other component of the seat 422.

In some embodiments, the motor module 432 can translate one or more of the components of the seat 422 along one or more axes. As an example, the motor module 432 can translate a component in a forwards or backwards direction (e.g., along an x-axis, a left or right direction (e.g., along a y-axis), an up or down direction (e.g., along a z-axis), or some combination thereof.

In some embodiments, the motor module 432 can rotate one or more of the components of the seat 422 about one or more axes. As an example, the motor module 432 can roll a component (e.g., rotate the component along the x-axis), pitch the component (e.g., rotate the component along the y-axis), yaw the component (e.g., rotate the component along the z-axis), or some combination thereof.

Further, as shown in FIG. 4C, at least some of the adjustment commands 420 can be transmitted to a motor module 440 of the seat belt adjustment system 412. The motor module 440 includes one or more actuators (e.g., hydraulic actuators, pneumatic actuators, electrical actuators, mechanical actuators, linear motors, etc.) that are configured to selectively move one or more of the components of a seat belt 442.

For example, the seat belt 442 can include a strap 444 extending between anchorages 446 and 448 (e.g., which secure the strap 444 to the frame of the vehicle 200), a tongue 454 attached to the strap 444, and a buckle 456 for receiving the tongue 454. A passenger can deploy the seat belt 442 by sitting in the seat 442, drawing the strap 444 across her body, and inserting the tongue 454 into the buckle 456. Further, the motor module 440 can selectively change the position and/or reorient the anchorage 446 (e.g., by sliding the anchorage 446 along a track 452, such as a linear rail). In some embodiments, the track 452 and the motor module 440 can be configured to enable the anchorage 446 to be translated in an up or down direction (e.g., along the z-axis).

In some embodiments, the adjustment system 400 can adjust the seating area of the vehicle 200, prior to the user entering the vehicle 200. For example, as the passenger 450 approaches the vehicle 200, the adjustment system 400 can obtain sensor data regarding the passenger 450, and preemptively adjust the configuration of the seat 422 and/or the seat belt 442 to accommodate the passenger 450, prior to the passenger entering the vehicle 200. Accordingly, the passenger 450 is less likely to make adjustments to the configuration of the seat 422 and/or the seat belt 442 area upon entering the vehicle 200, which may otherwise delay travel.

In some embodiments, the adjustment system 400 can predict a seat selection by the passenger 450, and preemptively adjust the configuration of that seat and/or the corresponding seat belt, prior to the passenger 450 entering the vehicle 200. For example, based on sensor data obtained by the sensor 408 the adjustment system 400 can determine that the passenger 450 is approaching a particular side of the vehicle 200, approaching a particular door of the vehicle 200, reaching for a particular door handle of the vehicle 200, and/or performing some other actions that indicates that the user is intending to select a particular seat in the vehicle 200. In response, the adjustment system 400 can adjusting the configuration of the seat and/or the seat belt corresponding to that side of the vehicle or that door of the vehicle.

In some embodiments, a passenger 450 can manually specify a seat selection to the adjustment system 400 (e.g., by manually inputting a seat selection into an application of a mobile device). In response, the adjustment system 400 can adjust the configuration of the seat and/or the seat belt corresponding to the selection (e.g., prior to the passenger 450 entering the vehicle 200).

Further, in some embodiments, the adjustment system 400 can also adjust the seating area of the vehicle 200, after the passenger 450 has entered the vehicle 200. For example, after the passenger has been seated in the seat 422, the adjustment system 400 can obtain sensor data regarding the passenger 450, and adjust the configuration of the seat 422 and/or the seat belt 442 to accommodate the passenger 450.

In some embodiments, the adjustment system 400 can also adjust the seating area of the vehicle 200, at least in part, in response to a facial expression of the passenger 450. For example, if the passenger 450 sits in the seating area of the vehicle 200 and expresses displeasure (e.g., by frowning or making some other disappointed facial expression), the adjustment system 400 can determine that the passenger 450 is uncomfortable, and make further adjustments of the configuration of the seat 422 and/or the seat belt 442 to accommodate the passenger 450.

Further, the adjustment system 400 can adjust the seating area of the vehicle 200 in a manner that improves the comfort and/or the safety of the passenger 450. For instance, the adjustment system 400 can adjust the configuration of the seat 422 and/or the seat belt 442 to accommodate the passenger's body dimensions, weight, skeletal structure, and/or body type (e.g., by positioning and orientating the components of the seat 422 and/or the seat belt 442 to support the passenger's body). For example, the back rest 426 can be positioned and oriented to provide back support for the passenger 450. As another example, the arm rest(s) 428 can be positioned and oriented such that the passenger 450 can rest her arms comfortably on the arm rest(s) 428. As another example, the head rest 424 can be positioned and oriented to support the user's head, and to reduce whiplash (e.g., in the event of a collision between the vehicle 200 and another object). As another example, the entirety of the seat 422 can be positioned and oriented to provide sufficient room for the passenger's feet (e.g., in a foot well in front of the seat 422). As another example, the anchorage 446 of the seat belt 442 can be positioned and oriented to accommodate the height of the passenger 200 (e.g., such that the strap 444 can be worm comfortable across the passenger's shoulder and torso.

In some embodiments, at least some of the adjustments made by the adjustment system 400 can be determined based on a computer-aided engineering (CAE) model or a finite element analysis (FEA) model. For example, a CAE model and/or a FEA model can be used to estimate the forces that are applied to a passenger and/or acceleration experienced by the passenger, given a particular seating area configuration and a particular dynamic event (e.g., a collision, impact, sudden change in speed or acceleration, etc.). Further, the CAE model and/or the FEA model can be used to determine adjustments to the seating area that would reduce those forces and/or accelerations to an acceptable level (e.g., less than a particular threshold force value and/or a particular threshold acceleration value).

Further, the adjustment system 400 can store data regarding the adjustments that were made for the passenger 450 for future retrieval. For example, the adjustment system 400 can store data indicating the identity of the passenger 450 and the configuration of the seat 422 and/or the seat belt 442 (e.g., in the database 404). If the passenger 450 subsequently uses the vehicle 200 again, the adjustment system 400 can retrieve the stored data, and adjust the seating area of the vehicle 200 to accommodate the passenger 450.

As another example, the adjustment system 400 can transmit data indicating the identity of the passenger 450 and the configuration of the seat 422 and/or the seat belt 442 to one or more remote systems (e.g., a cloud computing environment, the remote AV system 114, the fleet management system 116, the V2I system 118, etc.). If the passenger 450 subsequently uses the vehicle 200 or some other vehicle (e.g., another vehicle in a fleet), an adjustment system 400 of that vehicle can retrieve the stored data, and adjust the seating area of the vehicle to accommodate the passenger 450.

In at least some of the example embodiments described above, an adjustment system 400 adjusts the seating area of a vehicle 200 to accommodate the characteristics of a single passenger 450. However, in at least some embodiments, an adjustment system 400 can adjust the seating area of a vehicle 200 to accommodate multiple passengers concurrently.

For example, based on data obtained by the sensors 408, the adjustment system 400 can determine that multiple passengers (e.g., two, three, four, or more) are approaching the vehicle 200, standing or sitting by the vehicle 200, preparing the board the vehicle 200, etc. Further, the adjustment system 400 can determine characteristics regarding each of those passengers (e.g., in a similar manner as described above). Further still, the adjustment system 400 can predict a seat selection by each of the passengers, and adjust the configurations of the corresponding seat and/or seat belt to accommodate that passenger (e.g., in a similar manner as described above).

At least some of the techniques describe herein can be implemented using one or more machine learning models. As an example, FIG. 5A shows a diagram of an implementation of a machine learning model. More specifically, illustrated is a diagram of an implementation of a convolutional neural network (CNN) 520. For purposes of illustration, the following description of CNN 520 will be with respect to an implementation of CNN 520 by the adjustment system 400. However, it will be understood that in some examples CNN 520 (e.g., one or more components of CNN 520) is implemented by other systems different from, or in addition to, the adjustment system 400, such as the autonomous system 202. While CNN 520 includes certain features as described herein, these features are provided for the purpose of illustration and are not intended to limit the present disclosure.

CNN 520 includes a plurality of convolution layers including first convolution layer 522, second convolution layer 524, and convolution layer 526. In some embodiments, CNN 520 includes sub-sampling layer 528 (sometimes referred to as a pooling layer). In some embodiments, sub-sampling layer 528 and/or other subsampling layers have a dimension (i.e., an amount of nodes) that is less than a dimension of an upstream system. By virtue of sub-sampling layer 528 having a dimension that is less than a dimension of an upstream layer, CNN 520 consolidates the amount of data associated with the initial input and/or the output of an upstream layer to thereby decrease the amount of computations necessary for CNN 520 to perform downstream convolution operations. Additionally, or alternatively, by virtue of sub-sampling layer 528 being associated with (e.g., configured to perform) at least one subsampling function (as described below with respect to FIGS. 5B and 5C), CNN 520 consolidates the amount of data associated with the initial input.

The adjustment system 400 performs convolution operations based on the adjustment system 400 providing respective inputs and/or outputs associated with each of first convolution layer 522, second convolution layer 524, and convolution layer 526 to generate respective outputs. In some examples, the adjustment system 400 implements CNN 520 based on the adjustment system 400 providing data as input to first convolution layer 522, second convolution layer 524, and convolution layer 526. In such an example, the adjustment system 400 provides the data as input to first convolution layer 522, second convolution layer 524, and convolution layer 526 based on the adjustment system 400 receiving data from one or more different systems (e.g., the sensors 408 and/or the database 404). A detailed description of convolution operations is included below with respect to FIG. 5B.

In some embodiments, the adjustment system 400 provides data associated with an input (referred to as an initial input) to first convolution layer 522 and the adjustment system 400 generates data associated with an output using first convolution layer 522. In some embodiments, the adjustment system 400 provides an output generated by a convolution layer as input to a different convolution layer. For example, the adjustment system 400 provides the output of first convolution layer 522 as input to sub-sampling layer 528, second convolution layer 524, and/or convolution layer 526. In such an example, first convolution layer 522 is referred to as an upstream layer and sub-sampling layer 528, second convolution layer 524, and/or convolution layer 526 are referred to as downstream layers. Similarly, in some embodiments the adjustment system 400 provides the output of sub-sampling layer 528 to second convolution layer 524 and/or convolution layer 526 and, in this example, sub-sampling layer 528 would be referred to as an upstream layer and second convolution layer 524 and/or convolution layer 526 would be referred to as downstream layers.

In some embodiments, the adjustment system 400 processes the data associated with the input provided to CNN 520 before the adjustment system 400 provides the input to CNN 520. For example, the adjustment system 400 processes the data associated with the input provided to CNN 520 based on the adjustment system 400 normalizing sensor data (e.g., image data, LiDAR data, radar data, audio signals, and/or the like).

In some embodiments, CNN 520 generates an output based on the adjustment system 400 performing convolution operations associated with each convolution layer. In some examples, CNN 520 generates an output based on the adjustment system 400 performing convolution operations associated with each convolution layer and an initial input. In some embodiments, the adjustment system 400 generates the output and provides the output as fully connected layer 530. In some examples, the adjustment system 400 provides the output of convolution layer 526 as fully connected layer 530, where fully connected layer 530 includes data associated with a plurality of feature values referred to as F1, F2 . . . FN. In this example, the output of convolution layer 526 includes data associated with a plurality of output feature values that represent a prediction.

In some embodiments, the adjustment system 400 identifies a prediction from among a plurality of predictions based on the adjustment system 400 identifying a feature value that is associated with the highest likelihood of being the correct prediction from among the plurality of predictions. For example, where fully connected layer 530 includes feature values F1, F2, . . . FN, and F1 is the greatest feature value, the adjustment system 400 identifies the prediction associated with F1 as being the correct prediction from among the plurality of predictions. In some embodiments, the adjustment system 400 trains CNN 520 to generate the prediction. In some examples, the adjustment system 400 trains CNN 520 to generate the prediction based on the adjustment system 400 providing training data associated with the prediction to CNN 520.

In some implementations, training data can include sensor data and/or other data regarding one or more additional users (e.g., data similar to that described with reference to the sensors 408 and the database 404), and one or more corresponding outcomes associated with those users. For example, the training data can include sensor data and/or other data regarding one or more users who were previously observed by the vehicle 200, previously observed by another vehicle in the fleet, and/or previously observed in a different context (e.g., a standalone sensor system that is not associated with a vehicle). Further, the training data can include, for each user, information regarding a gait of that user, a skeletal structure or body type of that user, an age of that user, a gender of that user, an attire of that user, facial expression of that user, and/or an identity of that user. Further, the training data can include, for each user, information regarding the preferences of that user (e.g., preferences regarding the configuration of the seating area, such as the configuration of a seat and/or a seat belt). This training data can be used to train the CNN 520, such that given data regarding a passenger 450, the CNN 520 can predict characteristics of the passenger 450, and predict an adjustment to a seating area of the vehicle 200 to improve the comfort and/or safety of the passenger 450 while riding in the vehicle 200.

Referring now to FIGS. 5B and 5C, illustrated is a diagram of example operation of CNN 540 by the adjustment system 400. In some embodiments, CNN 540 (e.g., one or more components of CNN 540) is the same as, or similar to, CNN 520 (e.g., one or more components of CNN 520) (see FIG. 5A).

At step 550, adjustment system 400 provides data as input to CNN 540 (step 550). For example, the adjustment system 400 can provide data obtained by one or more of the sensors 408, such as one or more images, videos, LiDAR images, point clouds, radar images, audio signals, vital signs, eye position and movement measurements, vibration measurements, acceleration measurements, etc.) As another example, adjustment system 400 can provide data received from the database 404.

At step 555, CNN 540 performs a first convolution function. For example, CNN 540 performs the first convolution function based on CNN 540 providing the values representing the input data as input to one or more neurons (not explicitly illustrated) included in first convolution layer 542.

As an example, the values representing an image or video can correspond to values representing a region of the image or video (sometimes referred to as a receptive field). As another example, the values representing an audio signal can correspond to values representing a portion or the audio signal (e.g., a particular temporal portion and/or a particular spectral portion). As another example, the values representing some other sensor measurement can correspond to values representing a portion of that sensor measurement (e.g., a particular temporal portion and/or a particular spectral portion).

In some embodiments, each neuron is associated with a filter (not explicitly illustrated). A filter (sometimes referred to as a kernel) is representable as an array of values that corresponds in size to the values provided as input to the neuron. In one example, a filter may be configured to identify edges in an image (e.g., horizontal lines, vertical lines, straight lines, and/or the like). In successive convolution layers, the filters associated with neurons may be configured to identify successively more complex patterns in the image (e.g., arcs, objects, and/or the like). In successive convolution layers, the filters associated with neurons may be configured to identify patterns in other types of data (e.g., audio signals, accelerometer measurements, vital signs, eye tracking and movement measurements, etc.).

In some embodiments, CNN 540 performs the first convolution function based on CNN 540 multiplying the values provided as input to each of the one or more neurons included in first convolution layer 542 with the values of the filter that corresponds to each of the one or more neurons. For example, CNN 540 can multiply the values provided as input to each of the one or more neurons included in first convolution layer 542 with the values of the filter that corresponds to each of the one or more neurons to generate a single value or an array of values as an output. In some embodiments, the collective output of the neurons of first convolution layer 542 is referred to as a convolved output. In some embodiments, where each neuron has the same filter, the convolved output is referred to as a feature map.

In some embodiments, CNN 540 provides the outputs of each neuron of first convolutional layer 542 to neurons of a downstream layer. For purposes of clarity, an upstream layer can be a layer that transmits data to a different layer (referred to as a downstream layer). For example, CNN 540 can provide the outputs of each neuron of first convolutional layer 642 to corresponding neurons of a subsampling layer. In an example, CNN 540 provides the outputs of each neuron of first convolutional layer 542 to corresponding neurons of first subsampling layer 544. In some embodiments, CNN 540 adds a bias value to the aggregates of all the values provided to each neuron of the downstream layer. For example, CNN 540 adds a bias value to the aggregates of all the values provided to each neuron of first subsampling layer 544. In such an example, CNN 540 determines a final value to provide to each neuron of first subsampling layer 544 based on the aggregates of all the values provided to each neuron and an activation function associated with each neuron of first subsampling layer 544.

At step 560, CNN 540 performs a first subsampling function. For example, CNN 540 can perform a first subsampling function based on CNN 540 providing the values output by first convolution layer 542 to corresponding neurons of first subsampling layer 544. In some embodiments, CNN 540 performs the first subsampling function based on an aggregation function. In an example, CNN 540 performs the first subsampling function based on CNN 540 determining the maximum input among the values provided to a given neuron (referred to as a max pooling function). In another example, CNN 540 performs the first subsampling function based on CNN 540 determining the average input among the values provided to a given neuron (referred to as an average pooling function). In some embodiments, CNN 540 generates an output based on CNN 540 providing the values to each neuron of first subsampling layer 644, the output sometimes referred to as a subsampled convolved output.

At step 565, CNN 540 performs a second convolution function. In some embodiments, CNN 540 performs the second convolution function in a manner similar to how CNN 540 performed the first convolution function, described above. In some embodiments, CNN 540 performs the second convolution function based on CNN 540 providing the values output by first subsampling layer 544 as input to one or more neurons (not explicitly illustrated) included in second convolution layer 546. In some embodiments, each neuron of second convolution layer 546 is associated with a filter, as described above. The filter(s) associated with second convolution layer 546 may be configured to identify more complex patterns than the filter associated with first convolution layer 542, as described above.

In some embodiments, CNN 540 performs the second convolution function based on CNN 540 multiplying the values provided as input to each of the one or more neurons included in second convolution layer 546 with the values of the filter that corresponds to each of the one or more neurons. For example, CNN 540 can multiply the values provided as input to each of the one or more neurons included in second convolution layer 646 with the values of the filter that corresponds to each of the one or more neurons to generate a single value or an array of values as an output.

In some embodiments, CNN 540 provides the outputs of each neuron of second convolutional layer 546 to neurons of a downstream layer. For example, CNN 540 can provide the outputs of each neuron of first convolutional layer 542 to corresponding neurons of a subsampling layer. In an example, CNN 540 provides the outputs of each neuron of first convolutional layer 542 to corresponding neurons of second subsampling layer 548. In some embodiments, CNN 540 adds a bias value to the aggregates of all the values provided to each neuron of the downstream layer. For example, CNN 540 adds a bias value to the aggregates of all the values provided to each neuron of second subsampling layer 548. In such an example, CNN 540 determines a final value to provide to each neuron of second subsampling layer 548 based on the aggregates of all the values provided to each neuron and an activation function associated with each neuron of second subsampling layer 548.

At step 570, CNN 540 performs a second subsampling function. For example, CNN 540 can perform a second subsampling function based on CNN 540 providing the values output by second convolution layer 546 to corresponding neurons of second subsampling layer 548. In some embodiments, CNN 540 performs the second subsampling function based on CNN 540 using an aggregation function. In an example, CNN 540 performs the first subsampling function based on CNN 540 determining the maximum input or an average input among the values provided to a given neuron, as described above. In some embodiments, CNN 540 generates an output based on CNN 540 providing the values to each neuron of second subsampling layer 548.

At step 575, CNN 540 provides the output of each neuron of second subsampling layer 548 to fully connected layers 549. For example, CNN 540 provides the output of each neuron of second subsampling layer 548 to fully connected layers 549 to cause fully connected layers 549 to generate an output. In some embodiments, fully connected layers 549 are configured to generate an output associated with a prediction (sometimes referred to as a classification).

As an example, the output can include a prediction regarding a gait of the passenger 450. For example, the output can include a prediction regarding the passenger's step length, stride length, step cadence, walking speed, foot angle, hip angle, and/or any other metric regarding the gait of the passenger 450.

As another example, the output can include a prediction regarding a skeletal structure or body type of the passenger 450. For example, the output can include a prediction regarding the passenger's height, torso length, arm length, leg length, or any other dimension of the passenger's body. Further, the output can include a prediction regarding the passenger's posture (e.g., the position and/or orientation of one or more of the user's body parts relative to one another).

As another example, the output can include a prediction regarding a passenger's age and/or gender.

As another example, the output can include a prediction regarding a passenger's attire. For example, the output can include a prediction regarding whether a passenger is wearing a shirt, pants, a hat, a dress, a skirt, shorts, socks, eyewear (e.g., corrective glasses, sunglasses, etc.), and/or any other garment.

As another example, the output can include a prediction regarding a passenger's facial expressions. For example, the output can indicate a prediction regarding whether the passenger is smiling, frowning, staring, etc.

As another example, the output can include a prediction regarding a passenger's identity. For example, the output can include a prediction regarding the passenger's name, contact information, unique identifier, username or other login credentials, and/or any other information that identifies the passenger 450 from among several users.

In some embodiments, the adjustment system 400 performs one or more operations and/or provides the data associated with the prediction to a different system, as described herein.

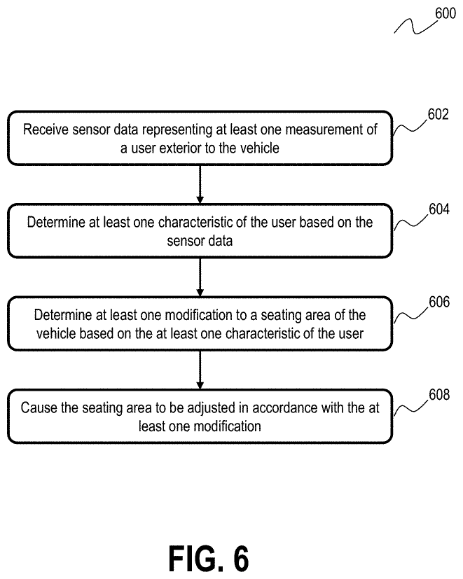

Referring now to FIG. 6, illustrated is a flowchart of a process 600 for automatically adjusting a vehicle seating area based on the characteristic of a passenger. In some embodiments, one or more of the steps described with respect to process 600 are performed (e.g., completely, partially, and/or the like) by the adjustment system 400. Additionally, or alternatively, in some embodiments one or more steps described with respect to process 600 are performed (e.g., completely, partially, and/or the like) by another device or group of devices separate from or including adjustment system 400, such as one or more other components of the vehicle 200, the remote AV system 114, the fleet management system 116, the V2I system 118, and/or the V2I device 110.

With continued reference to FIG. 6, a seat adjustment system of a vehicle (e.g., the adjustment system 400) receives sensor data representing at least one measurement of a user exterior to the vehicle (block 602). In some implementations, the sensor data can include at least some of the sensor measurements 414 described with reference to FIG. 4A. As an example, the sensor data can include a measurement obtained using a LiDAR sensor while the user is exterior to the vehicle. As another example, the sensor data can include an image obtained by a camera while the user is exterior to the vehicle. As another example, the sensor data can include a video obtained by the camera while the user is exterior to the vehicle.

With continued reference to FIG. 6, the system determines at least one characteristic of the user based on the sensor data (block 604). In some implementations, the determined character of the user can include at least some of the passenger characteristics 418 described with reference to FIG. 4A. As an example the characteristics of the user can include a height of the user, a weight of the user, an age of the user, a gender of the user, a gait of the user, a body type of the user, a skeletal structure of the user, and/or any combination thereof.

With continued reference to FIG. 6, the system determines at least one modification to a seating area of the vehicle based on the at least one characteristic of the user (block 606).

In some implementations, a modification to the seating area of the vehicle can include a modification to a position of a component in the seating area and/or a modification an orientation of the component in the seating area. Example components include component a headrest of the vehicle, an arm rest of the vehicle, a back rest of the vehicle, a seat cushion of the vehicle, and/or a seat belt of the vehicle.

In some implementations, at least one modification to the seating area can be determined based on a computer-aided engineering (CAE) model and/or a finite element analysis (FEA) model.

In some implementations, the system can also receive preference data representing one or more preferences of the user regarding the configuration of the seating area. Further, the system can determine at least one modification to the configuration to the seating area is determined further based on the preference data.

With continued reference to FIG. 6, the system causes the seating area to be adjusted in accordance with the at least one modification (block 608). In some implementations, the system can cause the seating area to be adjusted prior to the user entering the seating area (e.g., prior to the user entering and/or sitting in the vehicle). In some implementations, the system can cause the seating area to be adjusted subsequent to the user entering the seating area (e.g., subsequent to the user entering and/or sitting in the vehicle).

In some implementations, at least one modification can be determined based on a computerized neural network. Example computerized neural networks are described, for example, with reference to FIGS. 5A-5C.

Further, the system can train computerized neural network based on sets of training data regarding a multiple additional users. Each of the sets of training data can include first data representing at least one characteristic of a respective one of the additional users. Further, each of the sets of training data can include second data representing a configuration of the seating area for that additional user.

In some implementations, the computerized neural network can be trained, at least in part, by inputting at least one characteristic of the user into the computerized neural network. Further, system can determine at least one modification to the seating area based on an output of the computerized neural network.

In some implementations, the system can receive additional sensor data regarding the user (e.g., subsequent to the user entering the seating area). Further, the system can determine at least one additional characteristic of the user, determine at least one additional modification to the seating area of the vehicle based on the additional sensor data; and cause the seat seating area to be adjusted in accordance with the at least one additional modification.

In some implementations, determining the at least one additional characteristic of the user can include determining a position of a portion of a body of the user relative to a component of the seating area.

In some implementations, determining the at least one additional characteristic of the user can include determining a facial expression of the user.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

1. A method comprising:
receiving, by a seat adjustment system of a vehicle, sensor data representing at least one measurement of a user exterior to the vehicle;
determining, by the seat adjustment system, at least one characteristic of the user based on the sensor data;
determining, by the seat adjustment system, at least one modification to a seating area of the vehicle based on the at least one characteristic of the user; and
causing, by the seat adjustment system, the seating area to be adjusted in accordance with the at least one modification.

2. The method of claim 1, further comprising:
receiving, by the seat adjustment system, preference data representing one or more preferences of the user regarding the configuration of the seating area, and
wherein the at least one modification to the configuration to the seating area is determined further based on the preference data.

3. The method of claim 1, wherein receiving the sensor data comprises receiving at least one of:
a measurement obtained using a LiDAR sensor while the user is exterior to the vehicle,
an image obtained by a camera while the user is exterior to the vehicle, or
a video obtained by the camera while the user is exterior to the vehicle.

4. The method of claim 1, determining the at least one characteristic of the user comprises determining at least one of:
a height of the user,
a weight of the user,
an age of the user,
a gender of the user,
a gait of the user,
a body type of the user, or
a skeletal structure of the user.

5. The method of claim 1, wherein causing the seating area to be adjusted comprises causing the seating area to be adjusted prior to the user entering the seating area.

6. The method of claim 1, wherein causing the seating area to be adjusted comprises at least one of:
modifying a position of a component in the seating area, or
modifying an orientation of the component in the seating area.

7. The method of claim 6, wherein the component is at least one of:
a headrest,
an arm rest,
a back rest,
a seat cushion, or
a seat belt.

8. The method of claim 1, wherein determining the at least one modification to the seating area comprises determining the at least on modification based on a computerized neural network.

9. The method of claim 1, further comprising:
training the computerized neural network based a plurality of sets of training data regarding a plurality of additional users, where each of the sets of training data comprises:
first data representing at least one characteristic of a respective one of the additional users,
second data representing a configuration of the seating area for that additional user.

10. The method of claim 9, wherein training the computerized neural network comprises inputting the at least one characteristic of the user into the computerized neural network, and
wherein determining the at least one modification to the seating area comprises determining the at least one modification to the seating area based on an output of the computerized neural network.

11. The method of claim 1, wherein determining the at least one modification to the seating area comprises determining the at least one modification to the seating area based on at least one of a computer-aided engineering (CAE) model or a finite element analysis (FEA) model.

12. The method of claim 1, further comprising:
subsequent to the user entering the seating area, receiving additional sensor data regarding the user,
determining at least one additional characteristic of the user based on the additional sensor data;
determining at least one additional modification to the seating area of the vehicle based on the additional sensor data; and
causing the seat seating area to be adjusted in accordance with the at least one additional modification.

13. The method of claim 12, wherein determining the at least one additional characteristic of the user comprises:
determining a position of a portion of a body of the user relative to a component of the seating area.

14. The method of claim 1, wherein determining the at least one additional characteristic of the user comprises:
determining a facial expression of the user.

15. A system, comprising:
at least one processor, and
at least one non-transitory storage media storing instructions that, when executed by the at least one processor, cause the at least one processor to:
receive sensor data representing at least one measurement of a user exterior to a vehicle;
determine at least one characteristic of the user based on the sensor data;
determine at least one modification to a seating area of the vehicle based on the at least one characteristic of the user; and
cause the seating area to be adjusted in accordance with the at least one modification.

16. At least one non-transitory storage media storing instructions that, when executed by at least one processor, cause the at least one processor to:
receive sensor data representing at least one measurement of a user exterior to a vehicle;
determine at least one characteristic of the based on the sensor data;
determine at least one modification to a seating area of the vehicle based on the at least one characteristic of the user; and
cause the seating area to be adjusted in accordance with the at least one modification.
